(19) United States
(12) Patent Application Publication
(10) Pub. No.: US 2009/0175151 A1
(43) Pub. Date: Jul. 9, 2009

(54) OPTICAL DISC, OPTICAL DISC DRIVE, OPTICAL DISC RECORDING/REPRODUCING METHOD, AND INTEGRATED CIRCUIT

(75) Inventors: Harumitsu Miyashita, Nara (JP); Kohei Nakata, Nara (JP); Naohiro Kimura, Kyoto (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(73) Assignee: Panasonic Corporation, Kadoma-shi (JP)

(21) Appl. No.: 12/274,428

(22) Filed: Nov. 20, 2008

(30) Foreign Application Priority Data
Nov. 21, 2007 (JP) 2007-301517
Nov. 18, 2008 (JP) 2008-294338

(51) Int. Cl. G11B 7/00; G11B 7/24

(52) U.S. Cl. 369/112.23; 369/275.3; G9B/7

(57) ABSTRACT

An address format for appropriately controlling the recording linear density and the number of information recording layers is provided in order to increase the recording capacity of an information recording medium such as an optical disc or the like in a range in which a necessary S/N ratio can be guaranteed. An optical disc includes an information recording layer having a concentric or spiral track, and has a format for describing a track address, which is pre-recorded on the track or is to be added to data that is to be recorded on the information recording layer. The format includes layer information regarding the information recording layer and address information regarding the track address.

### BACKGROUND OF THE INVENTION

1. Field of the Invention

The present invention relates to a format of address information which is used for correctly recording or reproducing information at a prescribed position in an information recording medium such as an optical disc or the like, and a technology for recording or reproducing information in accordance with the address information format.

2. Description of the Related Art

Recently, research and development of high density optical discs has been actively conducted. Currently, for example, Blu-ray Disc (BD) has been proposed and put into practice, and is used for recording digital broadcast or the like. Optical discs are now establishing their position as an important information medium. For further increasing the density, research and development for providing a recording density expanded as compared with that of a BD of the current disc format is now being conducted. There are described in, for example, “Zukai Blu-ray Disc Dokuhon” (Blu-ray Handbook with Diagrams) published by Ohmsha, Ltd.

One conceivable method for increasing the recording capacity of one optical disc is to stack a plurality of recording layers (also referred to as “information recording layers”). FIG. 13 shows an example of a structure of a multi-layer phase change thin film disc. The optical disc shown in the figure includes (n+1) pieces of information recording layers 502. More specifically, the optical disc includes a cover layer 501, (n+1) pieces of information recording layers (Nn through L0 layers) 502, and a polycarbonate substrate 500 which are sequentially stacked from a surface on which laser light 505 is incident. Between the (n+1) pieces of information recording layers 502, spacer layers 503 acting as optical buffer members are inserted. By adopting a multi-layer structure while maintaining the recording capacity of each layer in this manner, the recording capacity of one optical disc can be increased.

Other conceivable methods for increasing the recording capacity of one optical disc include, for example, raising the recording linear density and/or narrowing the track pitch (width of the recording groove).

With the method of raising the recording linear density, the recording capacity can be increased by decreasing the length of the recording marks. For example, in the case of a BD having a recording capacity of 25 gigabytes (GB), the shortest mark length is 0.149 μm, which can be represented as “2T” using a reference length T. The recording capacity can be increased by decreasing the reference length T. “T” represents a reference channel time, and the T length is 0.0745 μm. For example, when the T length is increased from 0.0745 μm corresponding to 25 GB to about 0.062 μm, the recording capacity per layer can be increased to 30 GB.

With the method of narrowing the track pitch, the recording capacity can be increased by, for example, providing a track pitch narrower than the track pitch of 0.32 μm, which is provided in a BD.

Generally on an optical disc, address information defined by a prescribed format is described in order to correctly record or reproduce information at a prescribed position of the information recording medium. The address information may be inserted into a wobble signal represented by a wobble which is formed by winding a track, on which information is to be recorded, like a sine wave, or may be inserted inside the recorded information (data). These are described in, for example, Japanese Laid-Open Patent Publication No. 2004-134009.

FIG. 14 shows an example of a format of track addresses pre-recorded on a track of a conventional optical disc.

The track is divided into blocks by a data recording unit of 64 kilobytes (kB), and the blocks are sequentially assigned block address values. Each block is divided into sub blocks each having a prescribed length. Three sub blocks form one block. The sub blocks are assigned sub block numbers of 0 through 2 from the first sub block.

Digital information of 23 bits in total including 3-bit digital information representing a layer number in the multi-layer optical disc, 18-bit digital information representing a block address and 2-bit digital information representing a sub block number is pre-recorded on each sub block of the track. An optical disc apparatus for performing recording to or reproduction from the conventional optical disc reproduces the 23-bit digital information for each sub block and searches for a target block while following the layer numbers, the block addresses and the sub block numbers, and thus can perform data recording to or data reproduction from the target block.

By increasing the recording capacity as well as increasing, for example, the layer numbers, the block addresses and the sub block numbers in accordance with the method of increasing the recording capacity, a position corresponding to the increased recording capacity can be specified.

By stacking a plurality of information recording layers as well as raising the recording linear density, the recording capacity of one optical disc can be further increased. However, such a structure may occasionally make it difficult to construct a system for realizing stable data recording and/or reproduction.

First, when a plurality of information recording layers are provided to increase the recording capacity, the reproduction signal amplitude of each information recording layer is decreased, namely, the S/N ratio (Signal to Noise ratio; SNR) is deteriorated, at the time of reproduction due to the increase of the information recording layers. This requires an amplitude-variable amplifier allowing the amplitude to be varied in a wide range for compensating for the amplitude decrease and signal processing for maintaining the reproduction performance at a sufficient level despite the S/N ratio deterioration. In addition, the increase of the number of layers is conducted where the size range of the optical disc is restricted in the thickness direction in which the information recording layers are provided. Therefore, multi-layer stray light, i.e., an influence of a signal from an adjacent information recording layer is increased, which may further deteriorate the S/N ratio of the reproduction signal.

By contrast, with the method of raising the recording linear density to increase the recording capacity, the S/N ratio is deteriorated by a simple reason that the recording marks are shortened.

By the method of narrowing the track pitch to increase the recording capacity, the structure of the optical disc is significantly changed from the structure of a currently existing optical disc. Therefore, the optical structure of the optical disc apparatus needs to be significantly changed. From the viewpoint of keeping the optical disc apparatus compatible with optical discs of the current disc format, this method is not highly practical because the cost of the optical head is raised.

As described above, when a plurality of information recording layers are stacked while the recording linear density is raised to the recording capacity, the S/N ratio of a reproduction signal obtained by reproducing information from the optical disc is conspicuously deteriorated. This S/N ratio deterioration is more conspicuous as the number of the information recording layers is increased and the recording linear density is raised.

### SUMMARY OF THE INVENTION

The present invention made in light of the above-described problems has an object of providing an address format for a recording medium for appropriately controlling the recording linear density and the number of information recording layers in order to increase the recording capacity of the information recording medium such as an optical disc or the like in the range in which a necessary S/N ratio can be guaranteed. Another object of the present invention is to form a track address of an information recording medium with such an address format and construct an optical disc recording/reproducing system corresponding to such an address format.

An optical disc according to the present invention comprises an information recording layer having a concentric or spiral track, and has a format for describing a track address, which is pre-recorded on the track or is to be added to data that is to be recorded on the information recording layer. The format includes layer information regarding the information recording layer and address information regarding the track address. In the case where the optical disc is a first optical disc having a first recording density, the layer information of the first optical disc is described by a first number of bits, and the address information of the first optical disc is described by a second number of bits. In the case where the optical disc is a second optical disc having a second recording density higher than the first recording density, the layer information of the second optical disc is described by a number of bits smaller than the first number of bits, and the address information of the second optical disc is described by a number of bits larger than the second number of bits. A total number of bits of the layer information of the second optical disc and the address information of the second optical disc is equal to a total of the first number of bits and the second number of bits.

The optical disc may be of a read-only type, and the data may be formed by concave/convex pits.

A method according to the present invention for performing reproduction from the above-described optical disc comprises the steps of reproducing the layer information; and reproducing the address information.

An optical disc according to the present invention comprises an information recording layer. On the information recording layer, a format for describing a track address which is pre-recorded on a track or is to be added to data is pre-defined. The information recording layer includes an area for storing information regarding a recording density of the information recording layer. The format includes layer information regarding the information recording layer and address information regarding the track address, the layer information is described by a first number of bits, and the address information is described by a second number of bits. Where the information regarding the recording density exceeds a prescribed value, the layer information is described by a number of bits smaller than the first number of bits, the address information is described by a number of bits larger than the second number of bits, and a total number of bits of the layer information and the address information is equal to a total of the first number of bits and the second number of bits.

The optical disc may allow data to be recorded thereon using a plurality of types of marks having different lengths. A spatial frequency, which is a frequency of a reproduction signal obtained by reproducing at least one of the plurality of types of marks, may be higher than an OTF cutoff frequency.

In the optical disc, where laser light used for irradiating the track has a wavelength of λ nm, an objective lens for collecting the laser light to the track has a numerical aperture NA, the shortest recording mark recorded on the track has a length of TM nm, and the shortest mark has a length of TS nm, the relationship of (TM+TS)<λ/(2NA) may be fulfilled.

In the optical disc, TM+TS, which is obtained by adding the length TM of the shortest mark and the length TS of the shortest space, may be less than 238.2 nm.

On the optical disc, a plurality of types of marks modulated in compliance with a prescribed modulation rule are recordable; and where a reference cycle of the modulation is T, the length of the shortest mark may be 2T and the length of the shortest space may be 2T.

On the optical disc, a plurality of types of marks modulated in compliance with a prescribed modulation rule are recordable; and the prescribed modulation rule may be 1-7 modulation rule.

The information regarding the recording density may represent a recording capacity of the information recording layer.

The prescribed value may be 25 gigabytes.

The information regarding the recording density may represent a recording linear density of the information recording layer.

The track provided on the information recording layer may have a uniform width, and the optical disc may approve a plurality of recording densities.

The address information and the layer information may be represented by a wobble of the track or described inside data to be recorded; and a bit stream representing the layer information may be located at a position of more significant bits than the bit stream representing the address information.

The optical disc may comprise a BCA area and a lead-in area, and the lead-in area may include a PIC area; and the information regarding the recording density may be recorded in the BCA area or the PIC area.

A method according to the present invention for performing reproduction from the above-described optical disc comprises the step of reproducing information regarding the recording density from the BCA area or the PIC area.

The optical disc may comprise a reference layer, which is an information recording layer located at a position farthest from a light radiation surface; a first information recording layer located closer to the light radiation surface than the reference layer; and a first spacer layer located between the reference layer and the first information recording layer. The reference layer may include an area for storing the information regarding the recording density.

The optical disc may comprise a second information recording layer located closer to the light radiation surface than the first information recording layer; and a second spacer layer located between the first information recording layer and the second information recording layer. The first spacer layer may have a width larger than a width of the second spacer layer.

An optical disc apparatus according to the present invention is capable of performing at least one of data recording to, and data reproduction from, the above-described optical disc. The optical disc apparatus comprises output means for irradiating the optical disc with a light beam and outputting a reproduction signal in accordance with a light amount of the reflected light; first reproducing means for reproducing information regarding the recording density from the BCA area or the PIC area; second reproducing means for reproducing the layer information and the address information based on the reproduction signal; and recognition means for recognizing the layer information by a number of bits smaller than the first number of bits and recognizing the address information by a number of bits larger than the second number of bits, in accordance with the information regarding the recording density reproduced by the first reproducing means. The optical disc apparatus performs at least one of data recording and data reproduction based on the layer information and the address information recognized by the changed numbers of bits.

A control device according to the present invention incorporatable into an optical disc apparatus which is capable of performing at least one of data recording to, and data reproduction from, the above-described optical disc. The control device comprises first reproduction instruction means for issuing an instruction to reproduce information regarding the recording density from the BCA area or the PIC area; second reproduction instruction means for issuing an instruction to reproduce the layer information and the address information based on a reproduction signal from the optical disc; and recognition means for recognizing the layer information by a number of bits smaller than the first number of bits and recognizing the address information by a number of bits larger than the second number of bits, in accordance with the information regarding the recording density reproduced by the first reproduction instruction means.

In order to solve the above-described problems, an optical disc medium according to the present invention comprises at least two information recording layers, and has a format of a track address which is pre-formed, or is formed after data recording, on a track. The format includes at least layer information and address information, and is arranged such that the bit locations are changed in accordance with the recording linear density of the data to be recorded on the optical disc without changing the total number of bits of the layer information and the address information.

Where the frequency of the shortest mark recorded on the optical disc medium is higher than the OTF band, the recording linear density may be set such that the number of pieces of layer information is decreased as compared with where the frequency of the shortest mark is lower than the OTF band.

In the optical disc medium, the tracks on which data is to be recorded may have a uniform width in all the recording layers, and the optical disc may approve a plurality of recording linear densities.

The information regarding the number of pieces of layer information may be located at a position of more significant bits than the track address format information included inside the data to be recorded or inside the wobbling information.

The information representing the recording linear density may be recorded in the information in a BCA area or in a PIC area, pre-recorded on the optical disc medium.

An optical disc apparatus according to the present invention is for performing recording to or reproduction from an optical disc medium including at least two recording layers. The optical disc apparatus comprises physical information reproducing means for reproducing recording linear density information which is included in the information in a BCA area or in a PIC area, pre-recorded on the optical disc medium; and address reproducing means for reproducing at least layer information and address information included in a format of a track address which is pre-formed, or is formed after the recording, on a track of the optical disc medium. The address information is reproduced by changing the bit locations of the layer information and the address information which are to be reproduced by the address reproducing means, in accordance with the recording linear density information reproduced by the physical information reproducing means.

The recording linear density information may identify a case where the frequency of the shortest mark of the data to be recorded on the optical disc medium is higher than the OTF band as A, and identify a case where the frequency of the shortest mark is lower than the OTF band as B. The address information may be reproduced by changing the address information bit locations such that the number of pieces of layer information is decreased where the identification signal represents A than where the identification signal represents B.

An optical disc recording/reproducing method according to the present invention is for performing recording to or reproduction from an optical disc medium including at least two recording layers. The optical disc recording/reproducing method comprises a physical information reproducing step of reproducing recording linear density information which is included in the information in a BCA area or in a PIC area, pre-recorded on the optical disc medium; and an address reproducing step of reproducing at least layer information and address information included in a format of a track address which is pre-formed, or is formed after the recording, on a track of the optical disc medium. The address information is reproduced by changing the bit locations of the layer information and the address information to be reproduced by the address reproducing means, in accordance with the recording linear density information reproduced by the physical information reproducing means.

The recording linear density information may identify a case where the frequency of the shortest mark of the data to be recorded on the optical disc medium is higher than the OTF band as A, and identify a case where the frequency of the shortest mark is lower than the OTF band as B. The address information may be reproduced by changing the address information bit locations such that the number of pieces of layer information is decreased where the identification signal represents A than where the identification signal represents B.

An integrated circuit according to the present invention is for controlling recording to or reproduction from an optical disc medium including at least two recording layers. The integrated circuit comprises a physical information reproducing circuit for reproducing recording linear density information which is included; and an address reproducing circuit for reproducing at least layer information and address information included in a format of a track address which is pre-formed, or is formed after the recording, on a track of the optical disc medium. The address information is reproduced by changing the bit locations of the layer information and the address information to be reproduced by the address reproducing means, in accordance with the recording linear density information reproduced by the physical information reproducing means.

The recording linear density information may identify a case where the frequency of the shortest mark of the data to be recorded on the optical disc medium is higher than the OTF band as A, and identify a case where the frequency of the shortest mark is lower than the OTF band as B. The address information may be reproduced by changing the address information bit locations such that the number of pieces of layer information is decreased where the identification signal represents A than where the identification signal represents B.

According to the present invention, in order to increase the recording capacity of an information recording medium of an optical disc or the like, track addresses of the information recording medium are formed with an address format for appropriately controlling the recording linear density and the number of information recording layers, and an optical disc recording/reproducing system compatible with such an address format is constructed. Owing to this, a recording/reproducing system which is stable and also compatible with the conventional optical disc recording/reproducing system can be realized. An apparatus conventionally used can be used by merely changing the method of processing the value of the reproduced digital information. Therefore, it is not necessary to significantly change the hardware, and so an increase of the cost due to a complicated system or an enlarged scale of the hardware can be avoided.

### BRIEF DESCRIPTION OF THE DRAWINGS

FIG. 1 shows a physical structure of an optical disc 1 according to Embodiment 1.

FIG. 2 shows an example of a format of track addresses pre-recorded on a track 2 of the optical disc 1 according to Embodiment 1.

FIG. 3 shows an modification of the format of a disc B shown in FIG. 2.

FIG. 4(A) shows an example of a BD, and FIG. 4(B) shows an example of an optical disc having a higher recording density than that of the BD.

FIG. 5 shows how a mark recorded on the track is irradiated with a light beam.

FIG. 6 shows the relationship between the OTF and the shortest recording mark regarding a BD having a recording capacity of 25 GB.

FIG. 7 shows an example in which the spatial frequency of the shortest mark (2T) is higher than the OTF cutoff frequency and the amplitude of a 2T reproduction signal is 0.

FIG. 8 shows the relationship between the recordable data amount and the address value.

FIG. 9 shows a data structure and data address formats of the BD.

FIG. 10 is a block diagram showing a structure of an optical disc apparatus 450 according to Embodiment 2.

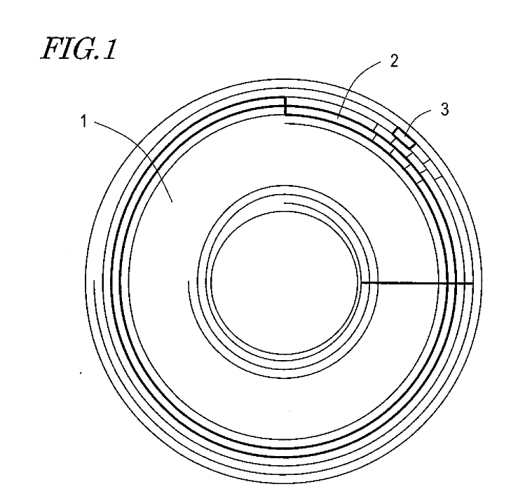

FIG. 1A shows an area arrangement of an optical disc 400.

FIG. 11B(1) shows a structure of an information recording layer of a disc A having the conventional recording density and the disc B having a higher recording density, and FIGS. 11B(2) and (3) respectively show a specific structure of a lead-in area 420 of the disc A and the disc B.

FIG. 12 shows an example of a procedure of an operation of the optical disc apparatus 450 when the optical disc apparatus 450 is started.

FIG. 13 shows an example of a structure of a multi-layer phase change thin film disc.

FIG. 14 shows an example of a format of track addresses pre-recorded on a track of a conventional optical disc.

### DETAILED DESCRIPTION OF PREFERRED EMBODIMENTS

### Embodiment 1

FIG. 1 shows a physical structure of an optical disc 1 according to this embodiment. On a Discus-Shaped Optical disc 1, a great number of tracks 2 are formed concentrically or in a spiral, for example. In each track 2, a great number of tiny sectors are formed. As described later, data is recorded on each track 2 in units of blocks 3 each having a predetermined size, as described later.

The optical disc 1 according to this embodiment has an expanded recording capacity per information recording layer as compared with a conventional optical disc (for example, a BD). The recording capacity is expanded by raising the recording linear density, for example, by decreasing the length of a recording mark recorded on the optical disc. Here, the expression “raising the recording linear density” means to decrease the channel bit length. The “channel bit length” refers to a length corresponding to the modulation reference cycle T when a mark is recorded by a prescribed modulation rule.

The optical disc 1 may include a plurality of layers. The number of layers is within a range describable by layer information of a format according to this embodiment described later. In the following, only one information recording layer will be described for the convenience of explanation.

Even where the width of the track is the same among a plurality of layers provided in the optical disc, the recording linear density may be varied on a layer-by-layer basis by uniformly changing the mark lengths on a layer-by-layer basis.

In correspondence with the expansion of the recording capacity, the method for describing the address is also expanded according to this embodiment. Hereinafter, this will be described specifically.

The track 2 is divided into blocks by a data recording unit of 64 kB (kilobytes), and the blocks are sequentially assigned block address values. Each block is divided into sub blocks each having a prescribed length. Three sub blocks form one block. The sub blocks are assigned sub block numbers of 0 through 2 from the first sub block.

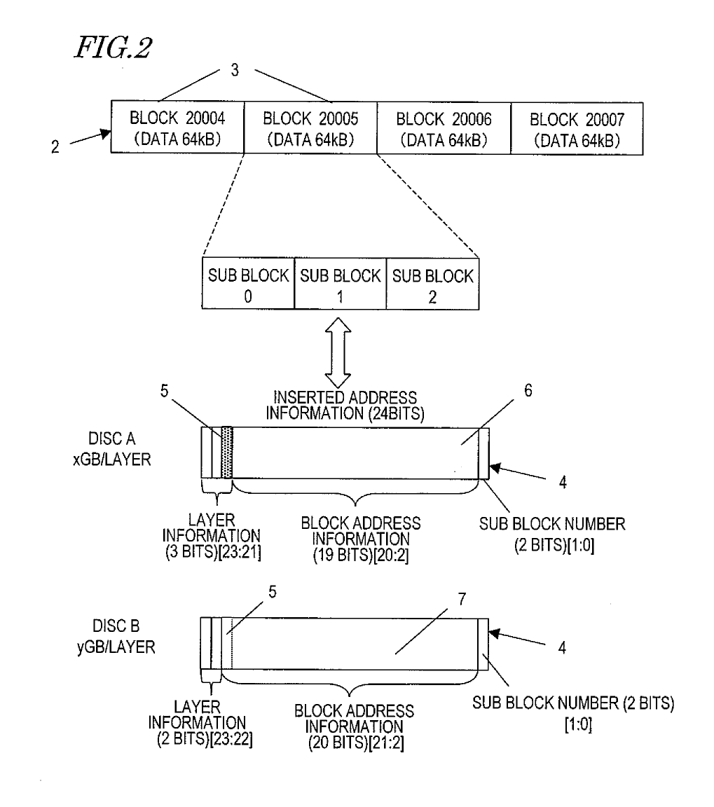

FIG. 2 shows an example of a format of track addresses pre-recorded on the track 2 of the optical disc 1 according to this embodiment. “Disc A: xGB/layer” is a format corresponding to the conventional optical disc shown for reference. “Disc B: yGB/layer” is a format corresponding to the optical disc according to this embodiment.

In an optical disc A having a recording density of xGB/layer, address information 4 is described by 24 bits in total including 3-bit layer information representing a layer number, 19-bit block address information 6 representing a block address, and 2-bit sub block number information representing a sub block number. The address information 4 is pre-recorded on the track 2 for each sub block.

An optical disc apparatus for performing recording to or reproduction from the conventional optical disc reproduces the 24-bit address information 4 for each sub block and searches for a target block while following the layer numbers, the block addresses and the sub block numbers, and thus can perform data recording to or data reproduction from the target block.

In this example, the layer information is described by the most significant 3 bits of the address information 4, and 8 layers in total can be represented by 0×0 through 0×7 (hexadecimal notation). The description method is as follows, for example. The position of the 21st bit (bit position 5) counted from the least significant bit 0 is set as the least significant bit of the layer information, and the position of the 23rd bit thus counted is set as the most significant bit of the layer information. The layer number is represented by the binary notation.

The 19-bit block address information 6 can represent an address in the range of 0×0000 through 0×7FFF. In the case of a BD, for example, the maximum possible value of the block address is 0×7FFFF, and user data of 65536 bytes (B) can be recorded per block. Accordingly, the maximum recordable capacity is about 32.2 GB.

The sub block number information assigned to the least significant 2 bits can represent 4 sub addresses in total by 0×0 through 0×3.

In a disc B having a recording density of yGB/layer (exceeding the above-mentioned xGB/layer per layer) according to this embodiment, the address information 4 is described by 24 bits in total, like the address information in the disc A mentioned above. Regarding the sub block number information also, the disc B is the same as the disc A.

However, the layer information, which is described by 3 bits in the disc A, is limited to 2 bits. In the disc B, the layer information is described by, for example, the 22nd and 23rd bits counted from the least significant bit.

1 bit located at the 21st bit (bit position 5) counted from the least significant bit, which is assigned to a part of the layer information in the disc A, is assigned to a part of block address information 7. Namely, the block address information 7 is digital information described by 20 bits.

When the format of the disc B according to this embodiment is adopted, the recording density per information recording layer is raised to a level higher than a prescribed level, while the permitted number of recording layers is limited to half by the address format. Namely, the permitted number of recording layers is physically restricted as compared with the conventional disc A. Owing to this, the number of layers can be restricted from increasing to such a level that the S/N ratio is deteriorated.

1 bit among 3 bits which are assigned to the layer information in the conventional disc A is used as a part of the block address information 7 in the disc B. Owing to this, the format can be used even where a larger number of block addresses need to be described by the raised recording density. Namely, a solution to a shortage of address bits can be provided.

As described above, the address format according to this embodiment changes the address arrangement of the optical disc where the recording density is equal to or higher than a prescribed level, in order to put a limit on the number of layers. Owing to this, a desired S/N ratio can be guaranteed.

In this example of the present invention, the bit arrangement shown in FIG. 2 is shown as a specific example. The present invention is not limited to this. The locations of the layer information bits, the block address bits and the sub block bits may be different. The number of bits may also be different.

In the above example, among the 24 bits of the address information, the 22nd bit counted from the least significant bit is converted to the address information in order to put a limit on the number of bits assigned to the layer information, which is described by the most significant 3 bits conventionally. The method of re-assigning a layer information bit to a block address bit is not limited to this. Even the 23rd bit or the 24th bit, namely, any bit information representing the layer information can be converted to the address information. Neither the number of bits nor the bit positions to be assigned is limited to the above.

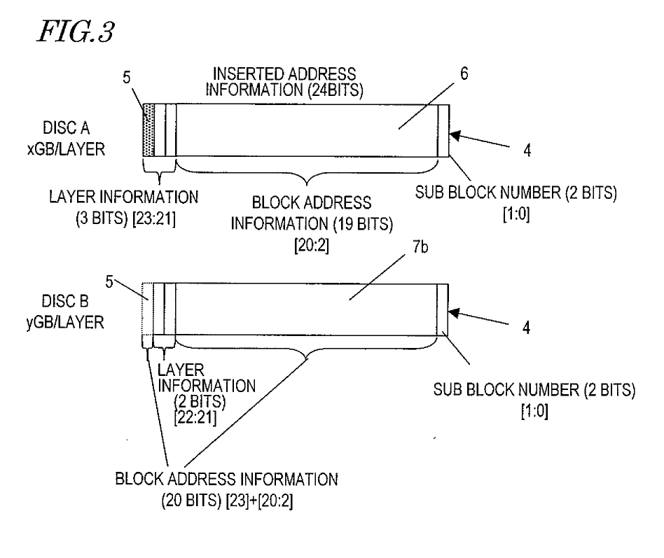

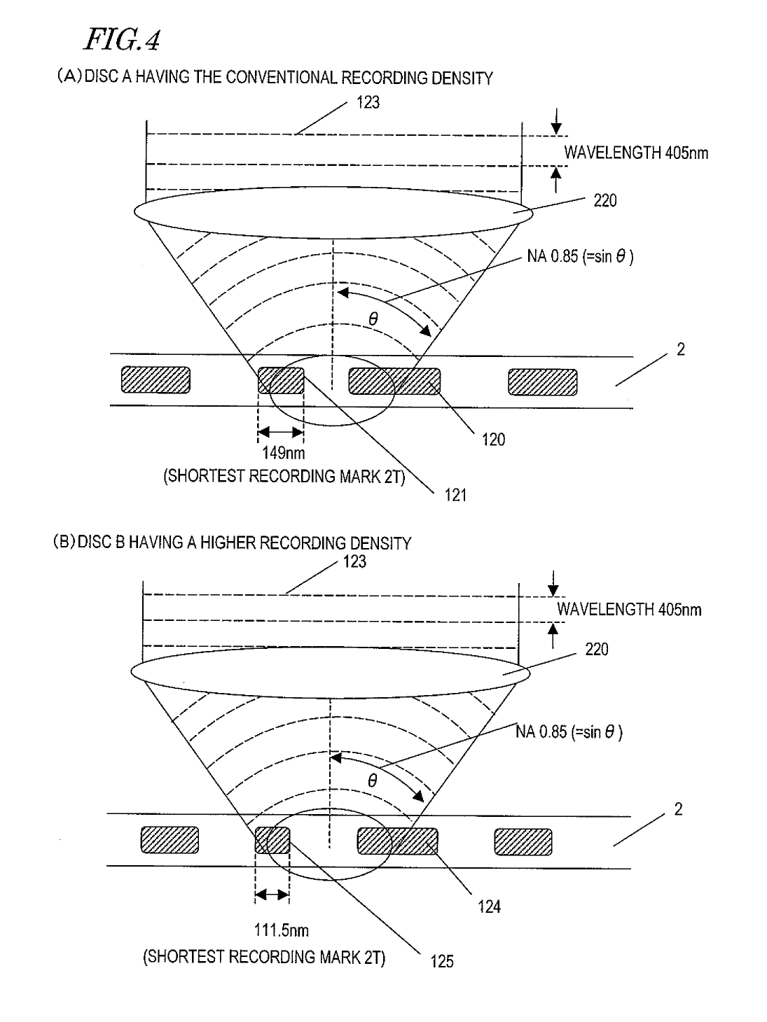

For example, FIG. 3 shows a modification of the format of the disc B shown in FIG. 2. In this example, the most significant bit (bit position 5) among the 3 bits which are used for the layer information in the disc A is used as a part of the block address information in the disc B. As a result, the block address information is represented by 20 bits also in this example. Except for this, the arrangement in FIG. 3 is the same as that in FIG. 2 and will not be described.

According to this arrangement, in both the disc A and the disc B, the least significant 2 bits of the layer information are always the 21st bit and the 22nd bit counted from the least significant bit. An apparatus usable for both of the discs can always acquire the layer information by reading the bit value of the same bit positions representing the least significant two bits of the layer information.

For example, in the case where the layer information in a single layer disc or the layer information on the first layer in a multi-layer disc is described as “000”, the layer information on the second layer in the multi-layer disc is described as “001”, the layer information on the third layer in the multi-layer disc is described as “1010”, the layer information on the fourth layer in the multi-layer disc is described as “011”, the layer information on the fifth layer in the multi-layer disc is described as “100”, et seq., the most significant bit of the layer information used for a disc including five or a larger number of layers (five through eight layers) is used as address information. Namely, the least significant 2 bits can be acquired by reading the bits at the same positions, and therefore no change is necessary for acquiring the layer information of a disc including four or a smaller number of layers.

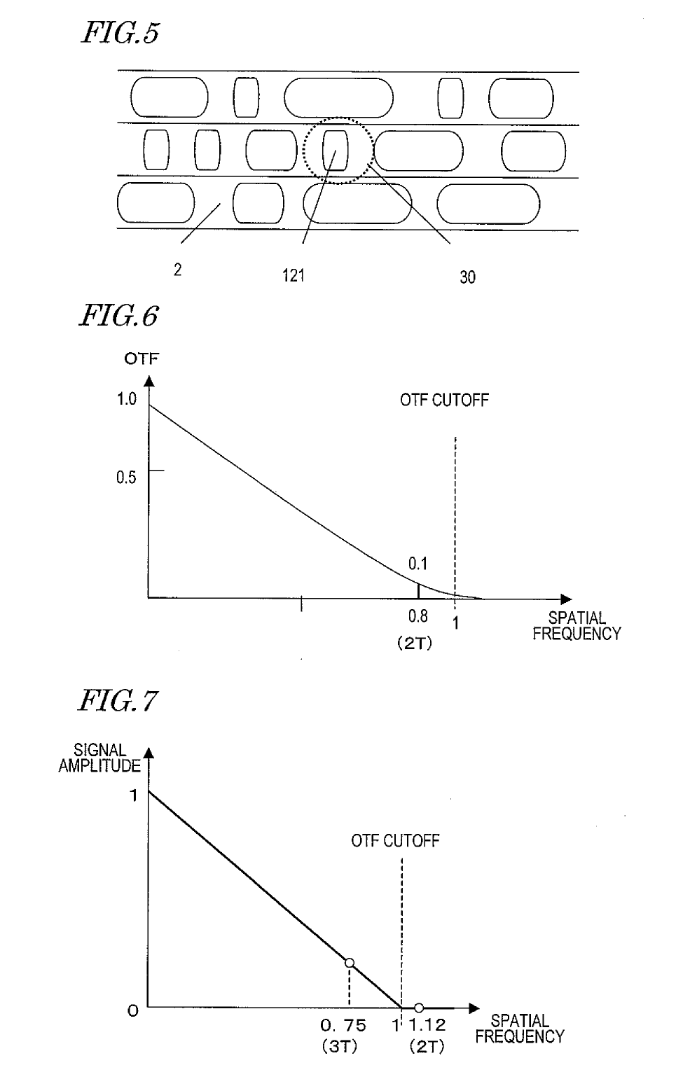

Now, the recording linear density, in accordance with which the limit on the number of information recording layers is changed, will be described regarding a BD given as a specific example, with reference to FIG. 4, FIG. 5 and FIG. 6.

FIG. 4(A) shows an example of a BD. For the BD, the wavelength of laser light 123 is 405 nm and the numerical aperture (NA) of an objective lens 220 is 0.85. The BD corresponds to the disc A in FIG. 2 described above.

Like in a DVD, in the BD also, the recording data is recorded as marks 120 and 121 formed by a physical change on the track 2 of the optical disc. A mark having the shortest length among these marks is referred to as the “shortest mark”. In the figure, the mark 121 is the shortest mark.

In the case of the BD having a recording capacity of 25 GB, the physical length of the shortest mark is 0.149 μm. This corresponds to about 1/2.7 of that of a DVD. Even if the resolving power of the laser light is raised by changing the parameters of the wavelength (405 nm) and the NA (0.85) of the optical system, the physical length of the shortest mark is close to the limit of the optical resolving power, i.e., the limit at which a light beam can identify a recording mark.

FIG. 5 shows how a mark recorded on the track is irradiated with a light beam. In the BD, an optical spot 30 has a diameter of about 0.39 μm because of the above-mentioned parameters of the optical system. When the recording linear density is raised without changing the structure of the optical system, the recording mark becomes small with respect to the diameter of the optical spot 30, and therefore the resolving power for reproduction is declined.

For example, FIG. 4(B) shows an example of an optical disc having a higher recording density than that of the BD. This optical disc corresponds to the disc B in FIG. 2 described above. For this disc also, the wavelength of the laser light 123 is 405 nm and the numerical aperture (NA) of the objective lens 220 is 0.85. A mark shortest among the marks 125 and 124, namely, the mark 125, has a physical length of 0.1115 μm. As compared with the BD shown in FIG. 4(A), in the disc in FIG. 4(B), the diameter of the spot is the same at about 0.39 μm but the recording mark is smaller and the inter-mark gap is narrower. Therefore, the resolving power for reproduction is declined.

An amplitude of a reproduction signal obtained by reproducing a recording mark using a light beam decreases as the recording mark is shortened, and becomes almost zero at the limit of the optical resolving power. The inverse of the cycle of the recording mark is called “spatial frequency”, and the relationship between the spatial frequency and the signal amplitude is called OTF (Optical Transfer Function) The signal amplitude decreases almost linearly as the spatial frequency increases. The critical frequency for reproduction at which the signal amplitude becomes zero is called “OTF cutoff”.

FIG. 6 shows the relationship between the OTF and the shortest recording mark regarding the BD having a recording density of 25 GB. The spatial frequency of the shortest recording mark of the BD is about 80% with respect to the OTF cutoff, which is close to the OTF cutoff. It is also seen that the amplitude of the reproduction signal of the shortest mark is very small at about 10% of the maximum detectable amplitude. For the BD, the recording capacity at which the spatial frequency of the shortest recording mark is the OTF cutoff, i.e., the recording capacity at which the reproduction amplitude of the shortest mark is almost zero, is about 31 GB. When the frequency of the reproduction signal of the shortest mark is around, or exceeds, the OFF cutoff frequency, the resolving power of the laser light is close to the limit or may exceed the limit. In such an area, the amplitude of the reproduction signal decreases and the S/N ratio is drastically deteriorated.

For example, FIG. 7 shows an example in which the spatial frequency of the shortest mark (2T) is higher than the OTF cutoff frequency and the amplitude of a 2T reproduction signal is 0. The spatial frequency of the shortest bit length, 2T, is 1.12 times of the OTF cutoff frequency. This example shows the relationship between the OTF and the shortest recording mark of an optical disc having a higher recording density than that of the BD shown in FIG. 3.

The relationship among the wavelength, the numerical aperture, and the length of a mark/space in the disc B having a high recording density is as follows.

Where the three parameters, i.e., the laser light wavelength λ (405 nm±5 nm, i.e., 400 through 410 nm), the NA (0.85±0.01, i.e., 0.84 through 0.86), and the length P of the shortest mark+the shortest space (in the case of 17 modulation, P=2T+2T−4T) are used, when the reference T decreases to fulfill P<λ/2NA, the OTF cutoff frequency is exceeded.

The reference T corresponding to the OTF cutoff frequency when NA=0.85 and λ=405 is:

T=405/(2×0.85)/4=59.558 nm.

As described above, merely by raising the recording linear density, the S/N ratio is deteriorated due to the limit of the optical resolving power. Hence, the S/N ratio deterioration caused by increasing the number of information recording layers may not be tolerable from the viewpoint of the system margin in some occasions. Especially, the S/N ratio deterioration is conspicuous when the frequency of the shortest recording mark is around, or exceeds, the OTF cutoff frequency as described above. Therefore, in order to maintain a prescribed S/N ratio, the number of information recording layers needs to be limited to prevent the S/N ratio from being deteriorated by the increase of the number of information recording layers.

As described above, in this embodiment, for recording information with a recording density per information recording layer which is equal to or higher than a prescribed level, the address format of the optical disc is changed in order to put a limit on the layer information. Owing to this, the number of the recording layers can be physically limited. As a result, an S/N ratio at which the system margin of a prescribed or higher level is guaranteed can be obtained and a stable recording/reproducing system can be realized. The “recording density which is equal to or higher than a prescribed level” corresponds to, for example, a capacity of about 32.2 GB in the BD format. Thus, a specific example of the values of xGB/layer and yGB/layer shown in FIG. 2 is x=25 and y=33. The former is for the conventional BD, and the latter is for a disc having a recording density higher than that of the BD and corresponding to the “disc B” mentioned above (hereinafter, described as a “high density disc”).

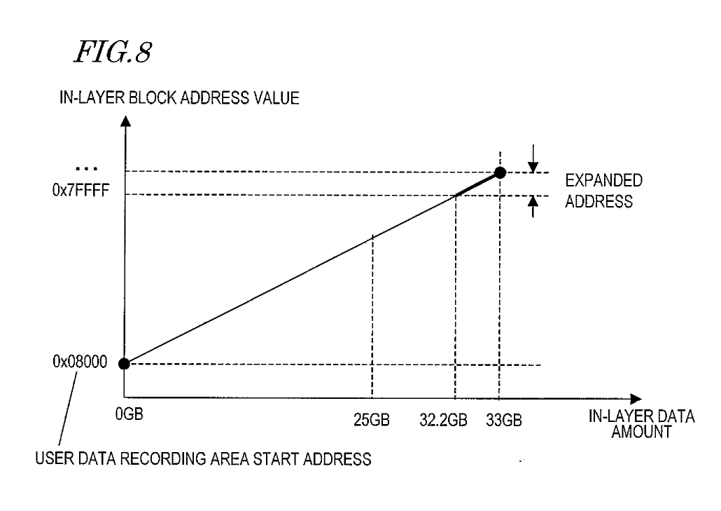

FIG. 8 shows the relationship between the recordable data amount and the address value corresponding to the above-described example. In the high density disc B (FIG. 1) having a larger recording area than about 32.2 GB, which is provided as the border, a block address is described by 20 bits which include an expanded 1 bit according to this embodiment. The expanded block address value can describe a value larger than 0×7FFFF.

The above explanation is given regarding an example of a method of describing an address which is added to a BD or a high density disc. An address is also added to data to be recorded on the BD or the high density disc.

Hereinafter, an address format added to data to be recorded on the BD will be described.

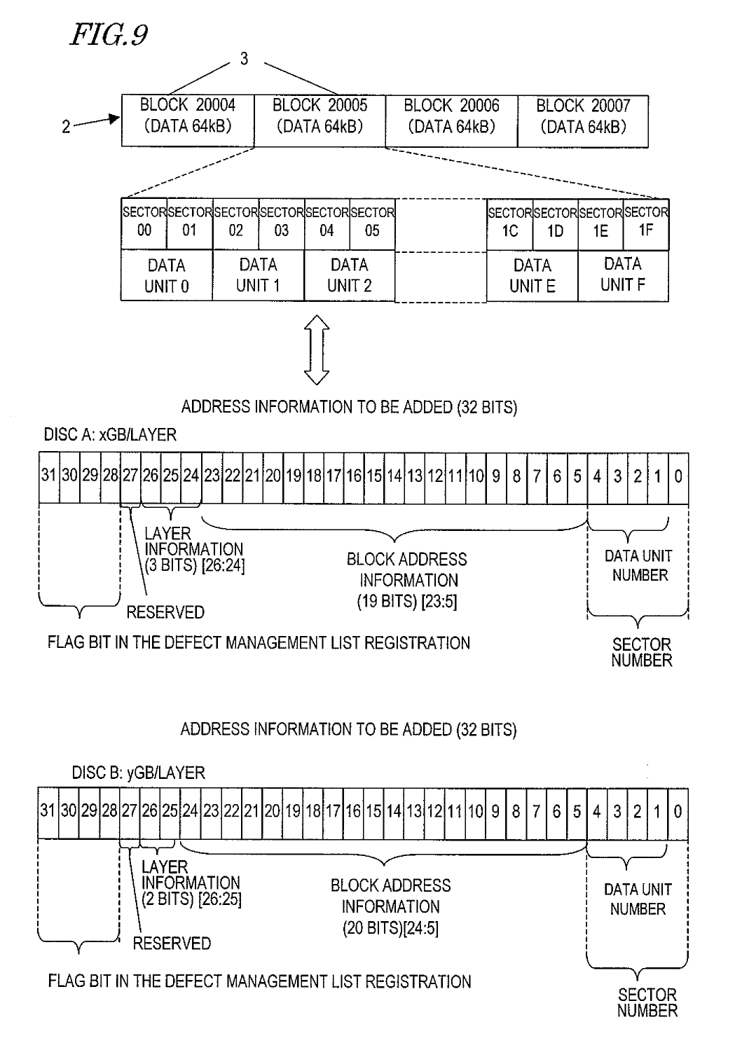

FIG. 9 shows a data structure common to the BD and the high density disc and data address formats of addresses to be added to data in the BD and the high density disc.

The data is divided into blocks each having 64 kB, and each block is recorded as being divided into 32 sectors each having 2 kB. Two sectors are collectively treated as a data unit, and each data unit is recorded on the track with 4-byte (32 bits)-data address information being added to the start thereof.

The data address to be added to the recording data is inserted to each data unit. One data unit includes 2 sectors.

In the BD (disc A), a data address is represented by 32 bits. The contents of the 32 bits are as follows. Sequentially from the most significant bit, bit numbers 31 through 28 are assigned as flag bits. A “flag bit” is added when the data address is registered as a defective data address to a defect management list provided in a file management area (not shown) of the BD. Bit number 27 is an unused reserved bit.

Bit numbers 26 through 24 represent a layer number of an information recording layer. Bit numbers 23 through 5 represent block address information. Bit numbers 4 through 1 represent a data unit number in the block. 5 bits including the bit numbers 4 through 1 and bit number 0 represent a sector number in the block.

The bit value of bit number 0 is fixed to “0”. The reason is that since the data address is added at the start of each data unit, an assigned sector number is always even-numbered.

In the high density disc (disc B), 1 bit among 3 bits assigned to the layer information in the BD is used as a part of the block address information like in the examples of FIG. 2 and FIG. 3 described above. As shown in FIG. 9, the 24th bit counted from the least significant bit of 0 is used as the most significant bit of the block address information. As a result, the layer information is represented by 2 bits.

In the above explanation, only 1 bit is re-assigned to the block address information. The present invention is not limited to this. A part of the number of bits may be assigned to the layer information and another part of the number of bits assigned to the format of a track address may be assigned to the address information, such that the number of bits for the layer information and the number of bits for the address information have a good balance at which a prescribed S/N ratio is guaranteed with a prescribed recording linear density and a prescribed number of recording layers.

### Embodiment 2

Now, an embodiment of an optical disc apparatus for performing layer information calculation or address calculation in accordance with the recording linear density will be described.

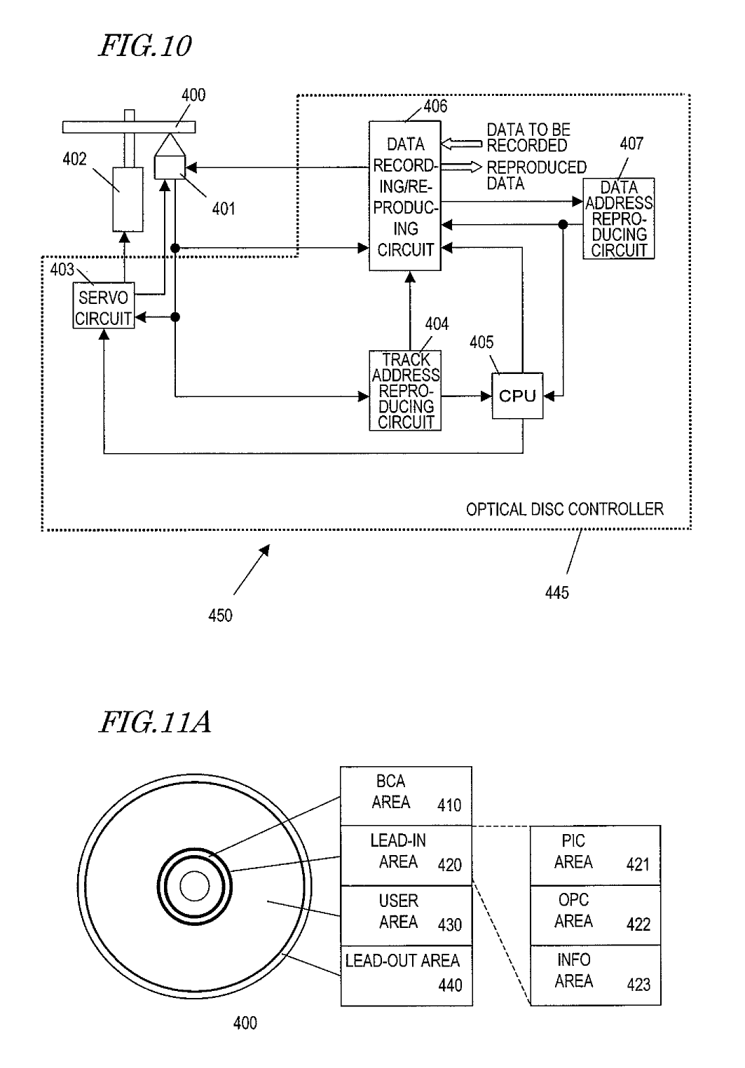

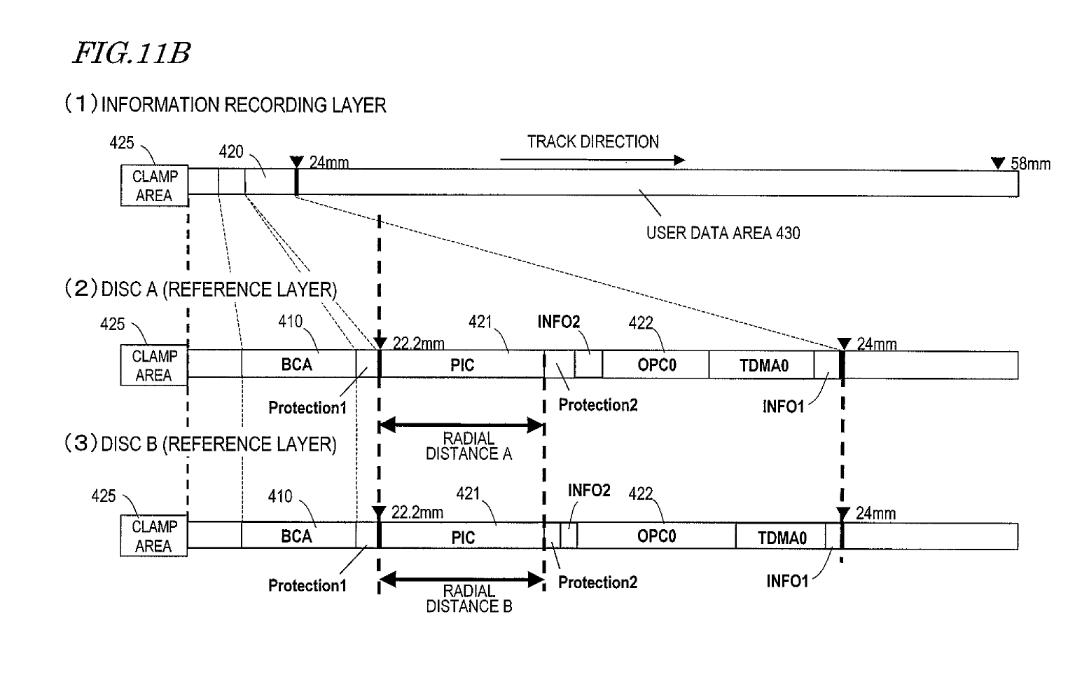

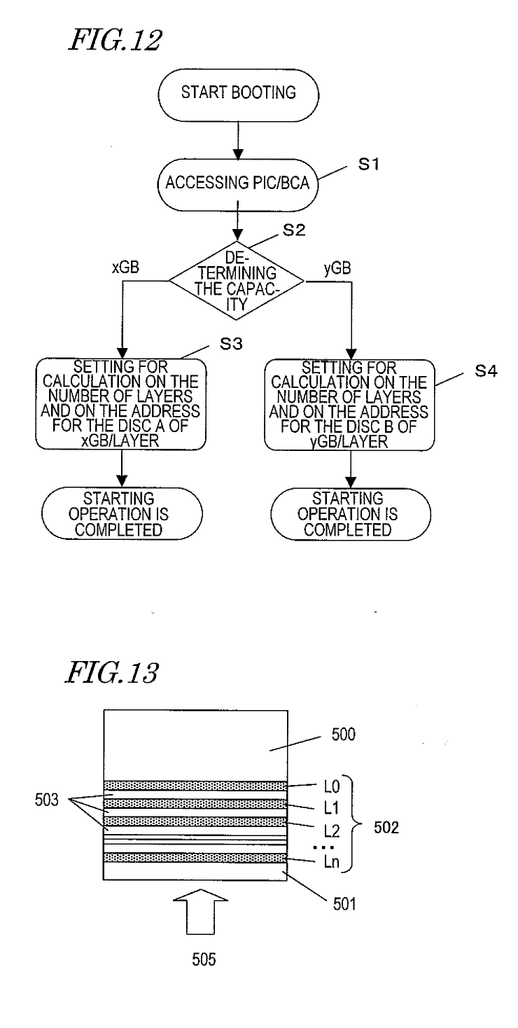

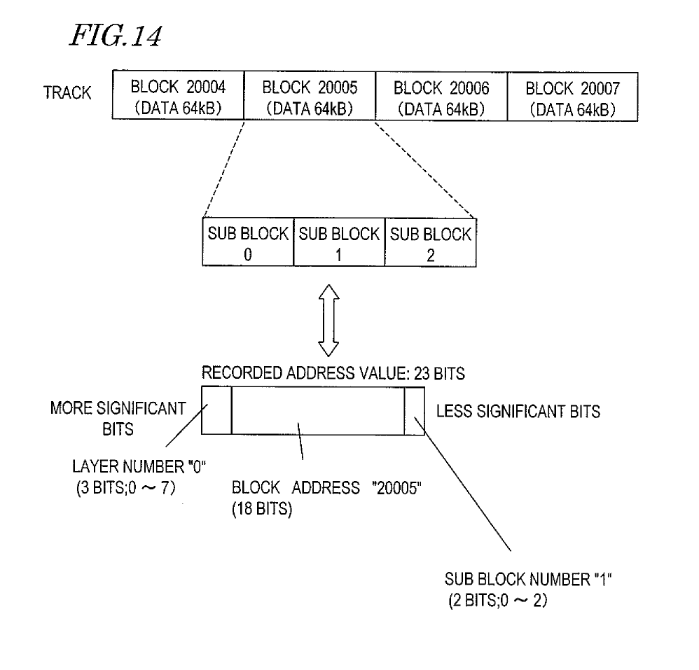

FIG. 10 is a block diagram showing a structure of an optical disc apparatus 450 according to this embodiment. The optical disc apparatus 450 is capable of reproducing data from an optical disc 400 and recording data to the optical disc 400. The function of recording data is not indispensable, and the optical disc apparatus 450 may be a read-only optical disc player. In this case, among the functions of a data recording/reproducing circuit of the optical disc apparatus 450 described later, the function of performing the processing of receiving recording data and writing the recording data to the optical disc 450 is not necessary.

The optical disc 400 is either the disc A or the disc B shown in FIG. 1. In accordance with which type of optical disc is mounted, the optical disc apparatus 450 switches the operation to be performed.

The optical disc apparatus 450 includes the optical disc 400, an optical head 401, a motor 402, a servo circuit 403, a track address reproducing circuit 404, a CPU 405, a data recording/reproducing circuit 406 and a data address reproducing circuit 407.

The servo circuit 403, the track address reproducing circuit 404, the CPU 405, the data recording/reproducing circuit 406, and the data address reproducing circuit 407 are mounted as a one-chip circuit (optical disc controller) 445. The optical disc controller 445 is incorporated into the optical disc apparatus 450 as a control device.

It is not necessary that all these elements are incorporated into one chip. For example, the servo circuit 403 does not need to be incorporated. The track address reproducing circuit 404 may be incorporated into the optical head 401. Alternatively, these elements may be provided as separate circuits instead of being incorporated into one chip.

The optical disc 400 has a track on which data is to be recorded. On the track, address values are recorded in accordance with an address format described above in Embodiment 1. The track is formed in a wobbling shape, and the address values are recorded by the modulation of the frequency or the phase of the wobble. Note that the optical disc 400 is dismountable from the optical disc apparatus 450 and so is not an indispensable element of the optical disc apparatus 450.

The optical head 401 irradiates the optical disc 400 with a light beam, detects the amount of the light reflected by the optical disc 400 while scanning the track, and outputs an electric signal (reproduction signal) in accordance with the amount of the reflected light. The optical head 301 includes a light source for emitting the light beam, a lens for collecting the light beam, and a light receiving section for receiving the light beam reflected by an information recording layer of the optical disc 300 and outputting the reproduction signal, although none of these elements is shown.

The motor 402 rotates the optical disc 400 at a specified rotation rate.

The servo circuit 403 generates a servo error signal in accordance with the light collection state of the light beam on the track, based on the reproduction signal from the optical head 401, and performs control using the servo error signal such that the light collection state of the light beam from the optical head 401 on the track and the scanning state of the track are optimal. The servo circuit 403 also controls the radial position on the optical disc 400 to be irradiated with the light beam and the rotation rate of the motor 402 to be optimal.

The track address reproducing circuit 404 extracts a wobble signal in accordance with the wobbling of the track of the optical disc 400, from the reproduction signal output from the optical head 401, and demodulates a 21-bit address value pre-recorded on the track based on the wobble signal. The track address reproducing circuit 404 also detects the synchronization position on the track for each block and each sub block.

The CPU 405 acquires the address value demodulated by the track address reproducing circuit 404, instructs the servo circuit 403 to search for a block which is to be used for data recording and reproduction, and issues an instruction to the data recording/reproducing circuit 406 to perform a recording operation or a reproduction operation at the position of the block obtained by the search. Thus, the data recording/reproducing circuit 406 controls the optical head 401 to output the laser light at a radiation power suitable to the recording operation or the reproduction operation to be performed.

In this embodiment, the CPU 405 performs calculation processing on the address value acquired from the track address reproducing circuit 404. Alternatively, this determination processing may be performed by the track address reproducing circuit 404.

When instructed by the CPU 405 to record data, the data recording/reproducing circuit 406 processes the recording data with addition of an error correction code, addition of a data address in accordance with a prescribed format and data modulation, and generates a recording signal. The data recording/reproducing circuit 406 controls the intensity of the light beam from the optical head 401, such that a mark in accordance with the recording signal is recorded on a specified block of the track, in compliance with the timing of the synchronization position detected by the track address reproducing circuit 404. Thus, the data is recorded on an information recording layer of the optical disc 300.

When instructed by the CPU 405 to reproduce data, the data recording/reproducing circuit 406 extracts a data signal in accordance with a mark recorded on a specified block of the track of the optical disc 400 based on the reproduction signal output from the optical head 301, in compliance with the timing of the synchronization position detected by the track address reproducing circuit 404. The data recording/reproducing circuit 406 then demodulates the data from the data signal in accordance with the above-mentioned data modulation of the recording operation, and also performs error correction processing, to output reproduction data.

At the time of the reproduction operation performed by the data recording/reproducing circuit 406, the data address reproducing circuit 407 extracts a data address added at the time of data recording, from the data demodulation result. The data address reproducing circuit 407 then detects a timing shift of the data demodulation or corrects the timing when abnormality occurs to the data signal due to a flaw on the track or the like.

Now, with reference to FIG. 11A, the structure of the optical disc 400 according to this embodiment will be described in detail.

FIG. 11A shows an area arrangement of the optical disc 400.

The optical disc 400 includes an information recording layer. By forming a recording mark on the information recording layer, data is recorded on the optical disc 400. On the optical disc 400, tracks are formed concentrically.

The optical disc 400 includes a BCA (Burst Cutting Area) area 410, a lead-in area 420, a user area 430 and a lead-out area 440.

The BCA area 410 has a bar code-like signal pre-recorded therein and includes a unique number for medium identification which is different disc by disc, copyright information, and disc characteristic information. The disc characteristic information includes the number of information recording layers and identification information on the address management method. As the disc characteristic information, information representing the number of information recording layers itself, prescribed bit information in accordance with the permitted number of information recording layers, or information on the recording density is, for example, included. As the information on the recording density, information representing the recording capacity of the optical disc or information representing the channel bit length (recording linear density) is, for example, included.

In a read-only disc, the information on the recording density may be stored in the BCA area and/or inside the recording data (concave/convex pits) (recorded as a data address added to the data). In a write once or rewritable recording disc, the information on the recording density may be stored in the BCA area and/or a PIC area, and/or a wobble (recorded as sub information superimposed on the wobble).

The user area 430 is structured to allow the user to record arbitrary data. In the user area 430, user data is recorded, for example. The user data includes, for example, audio data and visual (video) data.

Unlike the user area 430, the lead-in area 420 is not structured to allow the user to record arbitrary data. The lead-in area 420 includes a PIC (Permanent Information and Control area) area 421, an OPC (Optimum Power Calibration) area 422, and an INFO area 423.

The PIC area 421 has the disc characteristic information recorded therein. As the disc characteristic information, the number of information recording layers and the identification information of the address management method mentioned above, as well as access parameters, for example, are recorded. The access parameters include, for example, a parameter regarding a laser power for forming a plurality of recording marks to, or erasing a plurality of recording marks from, the optical disc 400, and a parameter regarding a recording pulse width for recording a plurality of recording marks on the optical disc 400.

In this embodiment, the disc characteristic information is stored in both of the BCA area 410 and the PIC area 421. This is a mere example, and the present invention is not limited to this. For example, the disc characteristic information may be stored either in the BCA area, in the PIC area, inside the recording data, or in the wobble; or in two or more thereof. Where the same disc characteristic information is recorded at a plurality of sites, such information can be read at any of the plurality of sites. This can guarantee the reliability of the disc characteristic information. Where the disc characteristic information is stored in predetermined areas, the optical disc apparatus can find the number of information recording layers of the disc and the like with certainty even if the type of disc is not known.

In the case where there are a plurality of information recording layers, the information recording layer having the disc characteristic information located thereon (reference layer) may be, for example, a layer farthest from the optical head, in other words, a layer deepest from the surface on which the laser light is incident.

In order to make the optical disc compatible with conventional optical disc apparatuses produced to be used only for BDs, it is desirable that the track address format is changed for each recording linear density such that the layer information on the reference layer is not changed from in the conventional art.

Hereinafter, with reference to FIG. 11B, this will be described in more detail.

FIG. 11B(1) shows a structure of an information recording layer of the disc A having the conventional recording density and the disc B having a higher recording density. FIGS. 11B(2) and (3) respectively show a specific structure of the lead-in area 420 of the disc A and the disc B.

FIG. 11B(1) shows an information recording layer of an optical disc. Sequentially from the innermost side (left in the figure), a clamp area, the BCA area 410, the lead-in area 420 and the user data area 430 are located.

FIG. 11B(2) shows a specific example of an arrangement of the lead-in area 420 of the reference layer of the disc A. The PIC area 421 has a prescribed radial distance A from a radial position of 22.2 mm. FIG. 11B(3) shows a specific example of an arrangement of the lead-in area 420 of the reference layer of the disc B. The PIC area 421 has a prescribed radial distance B from a radial position of 22.2 mm. What is characteristic here is that the radial distance B of the PIC area 421 of the disc B is the same as the radial distance A of the PIC area 421 of the disc A.

When information is recorded in the PIC area 421 on the disc B simply with a higher recording density, the channel bit length ought to be shorter and the radial distance B of the PIC area 421 also ought to be shortened in proportion thereto. However, the PIC area 421 of the disc B stores important information for accesses and so needs to be kept safely reproduceable. For example, an optical disc drive which reads information stored in the PIC area 421 by mechanically moving the optical disc to a predetermined position with high precision may not reproduce the information when the radial distance of the PIC area 421 is shortened. In order to keep lower compatibility with such a drive, it is preferable that the radial distance B is the same as the radial distance A.

For example, the following two methods are conceivable for making the radial distance B the same as the radial distance A. A first method is to record information in the PIC area of the disc B at the same recording density as that of the disc A, instead of the recording density of the disc B. In this case, even within the lead-in area, the recording density may occasionally be varied position by position. A second method is to record information in the PIC area with the recording density of the disc B and increase the number of times the recording is repeated. The information to be recorded in the PIC area is important and so is recorded repeatedly in order to guarantee the reliability. Such recording is performed at a higher density and a larger number of times (for example, 7 times instead of 5 times) Thus, the radial distance B can be made the same as the conventional radial distance A.

The OPC area 422 is an area usable for recording or reproducing test data. By recording or reproducing the test data, an optical disc apparatus for accessing the optical disc 400 adjusts the access parameters (for example, adjusts the recording power, the pulse width, etc.).

The INFO area 423 is used for recording management information on the user area 430 and data for defect management of the user area 430 which are necessary for the apparatus which accesses the optical disc 400.

FIG. 12 shows an example of an operation of the optical disc apparatus when the optical disc apparatus starts to perform recording to or reproduction from optical discs of the same disc format with different recording capacities per layer.

First, the CPU 405 of the optical disc apparatus shown in FIG. 10 rotates the motor 402 at a prescribed rotation rate. The CPU 405 causes the optical head 401 to irradiate the optical disc 400 with laser light of a prescribed power and performs tracking and focusing control using the servo circuit 403.

In step S1, the CPU 405 moves the optical head 401 to the BCA area 410 or the PIC area 421 physically constructed in the vicinity of the innermost end of the optical disc 400. The CPU 405 acquires an address value demodulated by the track address reproducing circuit 404, instructs the servo circuit 403 to search for a position at which the disc characteristic information is to be reproduced, and issues an instruction to read the disc characteristic information from the position obtained by the search.

Based on the instruction, the data recording/reproducing circuit 406 reads the disc characteristic information, and based on the read disc characteristic information, reproduces the number of information recording layers and the identification information on the address management method.

In step S2, based on the disc characteristic information, the CPU 405 identifies the recording density for which the disc is structured.

For example, when the CPU 405 determines that the mounted disc is for xGB, the operation advances to step S3; whereas when CPU 405 determines that the mounted disc is for yGB, the operation advances to step S4.

In step S3, the CPU 405 sets itself to recognize the layer information and the block address information in compliance with an address management rule for an optical disc of xGB.

In step S4, the CPU 405 sets itself to recognize the layer information and the block address information in compliance with an address management rule for an optical disc of yGB.

The method for recognizing the layer information and the block address information at the respective recording capacities is as described above with reference to FIG. 2.

Namely, in the case of xGB, among 24 bits of the block address information, the most significant 3 bits are recognized as the layer information bits, the next most significant 19 bits are recognized as the block address information bits, and the least significant 2 bits are recognized as the sub block number. By contrast, in the case of yGB, among 24 bits of the block address information, the most significant 2 bits are recognized as the layer information bits, the next most significant 20 bits are recognized as the block address information bits, and the least significant 2 bits are recognized as the sub block number. For example, x=25 and y 33.

In step S3, the address is reproduced in compliance with the address management rule assigned for each recording linear density, the position at which the optical head 401 is currently located is accurately recognized, and the optical head 401 is moved to a prescribed position. Thus, a series of starting processing is completed.

In the case where the optical disc apparatus 450 performs focusing and tracking control on a layer different from the reference layer and thus reads address information before recognizing the disc characteristic information, the address position may possibly be incorrectly recognized. The reason is that the locations of the layer information and the block address information in such a layer are different from those in the reference layer. In order to avoid this, a spacer layer between the reference layer and the other layers may be made thicker than a spacer layer between the other layers, so that incorrect recognition of the address is prevented. For example, according to the disc format of two-layer BDs, the reference layer L0 is located at a depth of about 100 μm from the surface on which the laser light is incident, and L1 layer is located at a depth of about 75 μm. According to the present invention, in order to prevent the focusing and tracking control from being performed on the L1 layer by mistake, L1 layer and other recording layers to be located closer to the laser light incidence surface may be located closer to the laser light incidence surface than the depth of 75 μm. For example, L1 layer may be located at a depth of 70 μm. However, if the spacer layer between the reference layer and L1 layer has an excessively large width (thickness), it is difficult to obtain a sufficient width for the spacer layers between L2 layer and the other recording layers closer to the laser light incidence surface. Hence, the widths of the spacer layers need to be determined so as to provide a good balance such that the focusing and tracking control is not performed on L1 layer by mistake while the other spacer layers have a sufficient width.

In the above embodiments, specific examples of the address formats of the pre-recorded addresses and the data addresses to be recorded are shown. The data formats are not limited to these.

In the above embodiments, the address values are recorded on the track by the wobbling of the track. The present invention is not limited to this, and the address values may be recorded by inter-track pits or pits on the track.

In the above embodiments, an example of the optical disc apparatus usable for an optical disc on which data is recordable is described. The present invention is also applicable to an optical disc apparatus usable for a read-only optical disc having data pre-recorded thereon.

The elements of the optical disc apparatus according to the present invention can be implemented as an LSI, which is an integrated circuit. The elements of the optical disc apparatus may be individually formed as a one-chip device, or a part or the entirety thereof may be incorporated into a one-chip device.

Here, the integrated circuit is referred to as an LSI. The integrated circuit may be referred to as an IC, LSI, super LSI, or ultra LSI depending on the degree of integration.

The integrated circuit of the present invention is not limited to an LSI, and may be implemented as a dedicated circuit or a general purpose processor. An FPGA (Field Programmable Gate Array) which is programmable after the production of an LSI or a reconfigurable processor in which the circuit cell connection or setting in the LSI is reconfigurable may be used.

When another circuit integration technology replacing the LSI appears by the development of the semiconductor technologies or by derivation from the semiconductor technologies, such a technology may be used to integrate the functional blocks. Application of biotechnology or the like is one possibility.

Finally, a brief supplemental explanation will be given regarding a BD (Blu-ray disc) as an example of optical disc according to the present invention. The main optical constants and physical formats of a Blu-ray disc are disclosed in “Bluray Disc Reader” published by Ohmsha, Ltd. or the white papers put on the web site of the Blu-ray Association (http://www.blu-raydisc.com/).

For the BD, laser light having a wavelength of 405 nm (where the tolerable error range is ±5 nm, 400 to 410 nm) and an objective lens having NA=0.85 (where the tolerable error range is ±0.01, 0.84 to 0.86) are used. The track pitch is 0.32 μm. The channel clock frequency is 66 MHz (66.000 Mbits/s) at the BD standard transfer rate (1×), 264 MHz (264.000 Mbits/s) at the BD4X transfer rate, 396 MHz (396.000 Mbits/s) at the BD6X transfer rate, and 528 MHz (528.000 Mbits/s) at the BD8X transfer rate. The standard linear velocity (reference linear velocity, 1×) is 4.917 m/sec.

The thickness of a protective layer (cover layer) is decreased as follows as the numerical aperture is increased and so the focal distance is shortened. The thickness of the protective layer is also decreased in order to suppress the influence of a spot distortion caused by a tilt. In contrast to 0.6 mm in the case of a DVD, the thickness of the protective layer of a BD may be 10 to 200 μm among the total thickness of the medium of about 1.2 mm (more specifically, where the substrate has a thickness of about 1.1 mm, a transparent protective layer having a thickness of about 0.1 mm is provided in a single layer disc, and a protective layer having a thickness of about 0.075 mm and a spacer layer having a thickness of about 0.025 mm are provided in a two layer disc). In a disc including three or more layers, the thickness of the protective layer and/or the spacer layer is further decreased.

In order to protect such a thin protective layer against being damaged, a projection may be provided outside or inside a clamp area. Especially where the projection is provided inside the clamp area, the following advantages are provided in addition to protecting the protective layer against being damaged. Since the projection is close to the central hole of the disc, the load on the rotation spindle (motor), which would be otherwise caused due to the weight balance of the projection, can be alleviated, and the collision of the projection and the optical head can be avoided because the optical head accesses the information recording area outside the clamp area.

Where the projection is provided inside the claim area, the specific position of the projection may be as follows, for example, in a disc having an outer diameter of 120 mm. Where the central hole has a diameter of 15 mm and the clamp area is provided in a region from a diameter of 23 mm to a diameter of 33 mm, the projection is provided between the central hole and the clamp area, namely, in a region from a diameter of 15 mm to a diameter of 23 mm. In this case, the projection may be provided at a position a certain distance away from the central hole (for example, the projection may be separated from the edge of the central hole by equal to or more than 0.1 mm (or/and equal to or less than 0.125 mm)). Alternatively, the projection may be provided at a position a certain distance away from the clamp area (for example, the projection may be separated from the inner end of the clamp area by equal to or more than 0.1 mm (or/and equal to or less than 0.2 mm)). Still alternatively, the projection may be provided at a position a certain distance away both from the edge of the central hole and the inner end of the clamp area (specifically, the projection may be provided in a region from a diameter of 17.5 mm to a diameter of 21.0 mm). The height of the projection may be determined such that the protective layer is unlikely to be damaged or the disc is easily raised in terms of balance. If the projection is excessively high, another problem may arise. Hence, for example, the height of the projection may be equal to or less than 0.12 mm from the clamp area.

The stacking structure of the layers may be as follows. In the case of, for example, a one-sided disc used for information reproduction and/or recording with laser light incident on the side of the protective layer, where there are two or more recording layers, there are a plurality of recording layers between the substrate and the protective layer. The multi-layer structure in such a case may be as follows, for example. A reference layer (L0 layer) is provided at the position which is farthest from the light incidence surface and is away from the light incidence surface by a prescribed distance. Other layers (L1, L2, . . . Ln) are stacked on the reference layer toward the light incidence surface while the distance from the light incidence surface to the reference layer is kept the same as the distance from the light incidence surface to the recording layer in a single-layer disc (for example, about 0.1 mm). Unlike the “reference layer” described above, the “reference layer” mentioned here does not indispensably need to have the disc characteristic information. Needless to say, the disc characteristic information may be located on the “reference layer” mentioned here.

By keeping the distance to the farthest layer the same regardless of the number of layers in this manner, the following effects are provided. The compatibility can be maintained regarding the access to the reference layer. In addition, although the farthest layer is most influenced by the tilt, the influence of the tilt on the farthest layer is prevented from being increased as the number of layers increases. The reason is that the distance to the farthest layer is not increased even if the number of layers increases. By locating an area for storing the disc characteristic information or the information included therein regarding the recording density at least on the reference layer, the compatibility can also be maintained regarding the reading of such information.

Regarding the spot advancing direction/reproduction direction, either the parallel path or the opposite path is usable, for example. By the parallel path, the spot advancing direction/reproduction direction is the same in all the layers, namely, is from the innermost end toward the outermost end in all the layers, or from the outermost end toward the innermost end in all the layers. By the opposite path, where the spot advancing direction/reproduction direction is from the innermost end toward the outermost end in the reference layer (L0), the spot advancing direction/reproduction direction is from the outermost end toward the innermost end in L1 and is from the innermost end toward the outermost end in L2. Namely, the reproduction direction is from the innermost end toward the outermost end in Lm (m is 0 or an even number) and is from the outermost end toward the innermost end in Lm+1 (or is from the outermost end toward the innermost end in Lm (m is 0 or an even number) and is from the innermost end toward the outermost end in Lm+1). In this manner, the reproduction direction may be opposite between adjacent layers.

Now, the modulation system of the recording signal will be briefly described. For recording data (original source data/pre-modulation binary data) on a recording medium, the data is divided into parts of a prescribed size, and the data divided into parts of the prescribed size is further divided into frames of a prescribed length. For each frame, a prescribed sync. code/synchronization code stream is inserted (frame sync. area) The data divided into the frames is recorded as a data code stream modulated in accordance with a prescribed modulation rule matching the recording/reproduction signal characteristic of the recording medium (frame data area).

The modulation rule may be, for example, an RLL (Run Length Limited) coding system by which the mark length is limited. The notation “RLL(d,k)” means that the number of 0's appearing between 1 and 1 is d at the minimum and k at the maximum (d and k are natural numbers fulfilling d<k). For example, when d=1 and k=7, where T is the reference cycle of modulation, the length of the mark or space is 2T at the shortest and 8T at the longest. Alternatively, the modulation rule may be 1-7PP modulation, in which the following features [1] and [2] are added to the RLL(1,7) modulation. “PP” of 1-7PP is an abbreviation of Parity preserve/Prohibit Repeated Minimum Transition Length. [1] “Parity preserve” represented by the first “P” means that whether the number of l's of the pre-modulation source data bits is an odd number or an even number (i.e., Parity) matches whether the number of l's of the corresponding post-modulation bit pattern is an odd number or an even number. [2] “Prohibit Repeated Minimum Transition Length” represented by the second “P” means a mechanism for limiting the number of times the shortest marks and spaces are repeated on the post-modulation recording wave (specifically, a mechanism for limiting the number of times 2T is repeated to 6).

The prescribed modulation rule is not applied to the sync. code/synchronization code stream inserted between the frames. Therefore, the sync. code/synchronization code stream can have a pattern other than the code length restricted by the modulation rule. The sync. code/synchronization code stream determines the reproduction processing timing for reproducing the recorded data and so may include any of the following patterns.

From the viewpoint of distinguishing the sync. code/synchronization code stream from the data code stream more easily, a pattern which does not appear in the data code stream may be included. For example, a mark/space longer than the longest mark/space included in the data code stream or a repetition of such a mark/space may be included. Where the modulation system is 1-7 modulation, the length of the mark or space is limited to 2T through 8T. Therefore, a 9T mark/space longer than 8T mark/space, or a repetition of a 9T mark/space may be included, for example.

From the viewpoint of facilitating the synchronization lock-up processing or the like, a pattern having many mark-space transfers may be included. For example, among marks/spaces included in the data code stream, a relatively short mark/space or a repetition of such a mark/space may be included. Where the modulation system is 1-7 modulation, a 2T mark/space which is the shortest, a repetition thereof, a 3T mark/space which is the second shortest or a repetition thereof may be included, for example.

Here, an area including the synchronization code stream and the data code stream is referred to as a “frame area”, and a unit including a plurality of (e.g., 31) frame areas is referred to as an “address unit”. In an address unit, an inter-code distance between a synchronization code stream included in an arbitrary frame area of the address unit and a synchronization code stream included in a frame area other than the arbitrary frame area may be 2 or greater. The “inter-code distance” means the number of bits which are different between two code streams. Owing to the arrangement in which the inter-code distance is 2 or greater, even if a 1-bit shift error occurs in one of the streams to be read due to an influence of noise or the like during reproduction, such a stream is not identified as the other stream by mistake. Alternatively, the inter-code distance between a synchronization code stream included in a frame area located at the start of the address unit and a synchronization code stream included in a frame area located at a position other than the start of the address unit may be 2 or greater. Owing to such an arrangement, it is easily distinguished whether the synchronization code stream is at the start or not, or whether the synchronization code stream is at the junction of address units or not.

The term “inter-code distance” encompasses an inter-code distance in an NRZ notation of the code stream in the case of NRZ recording and also an inter-code distance in an NRZI notation of the code stream in the case of NRZI recording. Therefore, in the case of recording performed by the RLL modulation, “RLL” means that the number of continuous high-level or low-level signals on the recording wave of NRZI is limited and so means that the inter-code distance is 2 or greater in the NRZI notation.

The present invention provides a method useful for increasing the recording capacity of an information recording medium such as an optical disc or the like. Track addresses of an information recording medium are formed with an address format for appropriately controlling the recording linear density and the number of the information recording layers, an optical disc recording/reproducing system compatible with such an address format is constructed. Owing to this, a recording/reproducing system which is stable and also compatible with the conventional optical disc recording/reproducing system can be realized. An apparatus conventionally used can be used by merely changing the method of processing the value of the reproduced digital information. Therefore, it is not necessary to significantly change the hardware, and so an increase of the cost due to a complicated system or an enlarged scale of the hardware can be avoided. The present invention is usable for an optical disc medium having a large capacity, and an optical disc apparatus, an optical disc recording/reproducing method and an integrated circuit usable for such an optical disc.

What is claimed is:

1. An optical disc, comprising an information recording layer having a concentric or spiral track, the optical disc having a format for describing a track address, which is pre-recorded on the track or is to be added to data that is to be recorded on the information recording layer, wherein:
the format includes layer information regarding the information recording layer and address information regarding the track address;
in the case where the optical disc is a first optical disc having a first recording density,
the layer information of the first optical disc is described by a first number of bits, and
the address information of the first optical disc is described by a second number of bits;
in the case where the optical disc is a second optical disc having a second recording density higher than the first recording density,
the layer information of the second optical disc is described by a number of bits smaller than the first number of bits, and
the address information of the second optical disc is described by a number of bits larger than the second number of bits; and
a total number of bits of the layer information of the second optical disc and the address information of the second optical disc is equal to a total of the first number of bits and the second number of bits.

2. The optical disc of claim 1, wherein the optical disc is of a read-only type, and the data is formed by concave/convex pits.

3. A method for performing reproduction from the optical disc of claim 1, comprising the steps of:
reproducing the layer information; and
reproducing the address information.

4. An optical disc, comprising an information recording layer, wherein:
on the information recording layer, a format for describing a track address which is pre-recorded on a track or is to be added to data is pre-defined;
the information recording layer includes an area for storing information regarding a recording density of the information recording layer;
the format includes layer information regarding the information recording layer and address information regarding the track address, the layer information is described by a first number of bits, and the address information is described by a second number of bits; and
where the information regarding the recording density exceeds a prescribed value, the layer information is described by a number of bits smaller than the first number of bits; the address information is described by a number of bits larger than the second number of bits; and a total number of bits of the layer information and the address information is equal to a total of the first number of bits and the second number of bits.

5. The optical disc of claim 4, which allows data to be recorded thereon using a plurality of types of marks having different lengths, wherein a spatial frequency, which is a frequency of a reproduction signal obtained by reproducing at least one of the plurality of types of marks, is higher than an OTF cutoff frequency.

6. The optical disc of claim 4, wherein where laser light used for irradiating the track has a wavelength of λ nm, an objective lens for collecting the laser light to the track has a numerical aperture NA, the shortest recording mark recorded on the track has a length of TM nm, and the shortest mark has a length of TS nm, (TM+TS)<λ/(2NA).

7. The optical disc of claim 6, wherein TM+TS, which is obtained by adding the length TM of the shortest mark and the length TS of the shortest space, is less than 238.2 nm.

8. The optical disc of claim 6, wherein:
a plurality of types of marks modulated in compliance with a prescribed modulation rule are recordable; and
where a reference cycle of the modulation is T, the length of the shortest mark is 2T and the length of the shortest space is 2T.

9. The optical disc of claim 6, wherein:
a plurality of types of marks modulated in compliance with a prescribed modulation rule are recordable; and
the prescribed modulation rule is 1-7 modulation rule.

10. The optical disc of claim 4, wherein the information regarding the recording density represents a recording capacity of the information recording layer.

11. The optical disc of claim 10, wherein the prescribed value is 25 gigabytes.

12. The optical disc of claim 4, wherein the information regarding the recording density represents a recording linear density of the information recording layer.

13. The optical disc of claim 4, wherein the track provided on the information recording layer has a uniform width, and the optical disc approves a plurality of recording densities.

14. The optical disc of claim 4, wherein:
the address information and the layer information are represented by a wobble of the track or described inside data to be recorded; and
a bit stream representing the layer information is located at a position of more significant bits than the bit stream representing the address information.

15. The optical disc of claim 4, wherein:
the optical disc comprises a BCA area and a lead-in area, and the lead-in area includes a PIC area; and
the information regarding the recording density is recorded in the BCA area or the PIC area.

16. A method for performing reproduction from the optical disc of claim 15, comprising the step of reproducing information regarding the recording density from the BCA area or the PIC area.

17. The optical disc of claim 4, comprising:
a reference layer, which is an information recording layer located at a position farthest from a light radiation surface;
a first information recording layer located closer to the light radiation surface than the reference layer; and
a first spacer layer located between the reference layer and the first information recording layer;
wherein the reference layer includes an area for storing the information regarding the recording density.

18. The optical disc of claim 17, comprising:
a second information recording layer located closer to the light radiation surface than the first information recording layer; and
a second spacer layer located between the first information recording layer and the second information recording layer;
wherein the first spacer layer has a width larger than a width of the second spacer layer.

19. An optical disc apparatus capable of performing at least one of data recording to, and data reproduction from, the optical disc of claim 15, the optical disc apparatus comprising:
output means for irradiating the optical disc with a light beam and outputting a reproduction signal in accordance with a light amount of the reflected light;
first reproducing means for reproducing information regarding the recording density from the BCA area or the PIC area;
second reproducing means for reproducing the layer information and the address information based on the reproduction signal; and
recognition means for recognizing the layer information by a number of bits smaller than the first number of bits and recognizing the address information by a number of bits larger than the second number of bits, in accordance with the information regarding the recording density reproduced by the first reproducing means;
wherein the optical disc apparatus performs at least one of data recording and data reproduction based on the layer information and the address information recognized by the changed numbers of bits.

20. A control device incorporatable into an optical disc apparatus which is capable of performing at least one of data recording to, and data reproduction from, the optical disc of claim 15, the control device comprising:
first reproduction instruction means for issuing an instruction to reproduce information regarding the recording density from the BCA area or the PIC area;
second reproduction instruction means for issuing an instruction to reproduce the layer information and the address information based on a reproduction signal from the optical disc; and
recognition means for recognizing the layer information by a number of bits smaller than the first number of bits and recognizing the address information by a number of bits larger than the second number of bits, in accordance with the information regarding the recording density reproduced by the first reproduction instruction means.
